(19) United States
(12) Patent Application Publication
(10) Pub. No.: US 2007/0200660 A1
(43) Pub. Date: Aug. 30, 2007

(54) Antitheft apparatus for vehicle and vehicle antitheft system

(76) Inventors: Takeo Endo, Aichi (JP); Kouichi Masamura, Aichi (JP); Yoshihide Nakane, Aichi (JP); Takao Ozawa, Aichi (JP)

Correspondence Address: OLIFF & BERRIDGE, PLC, P.O. BOX 19928, ALEXANDRIA, VA, 22320, US

(21) Appl. No.: 10/587,175

(22) PCT Filed: Mar. 1, 2005
(86) PCT No.: PCT/JP05/03828

§ 371 Date: Jul. 25, 2006

(30) Foreign Application Priority Data
Mar. 9, 2004 (JP) 2004-066058

(51) Int. Cl. H04L 9/32

(52) U.S. Cl. 340/5.22; 340/5.61; 307/10.5; 340/5.23; 340/5.72

(57) ABSTRACT

Disclosed is an antitheft apparatus for a vehicle, which is installed on a vehicle and configured to allow operation of predetermined on-vehicle devices only when a user ID code obtained from a user of the vehicle and a reference ID code registered on the vehicle are identical. The antitheft apparatus is provided with a setting unit for adding or deleting the reference ID code to or from the vehicle and a transmitting unit for transmitting the reference ID code registered on the vehicle to a predetermined communications station. A vehicle antitheft system using such apparatus is also disclosed.

### TECHNICAL FIELD

This invention relates generally to an antitheft apparatus for a vehicle using an immobilizer, and more particularly to an antitheft apparatus for a vehicle and a vehicle antitheft system, which enable remote recognition of immobilizer identification (ID) codes registered on the vehicle.

### BACKGROUND ART

An immobilizer, which is an electronic movement-locking device mainly intended for antitheft, is known as a security system for a vehicle. In Europe, immobilizers have been required to be installed into vehicles as standard equipment since 1997. In Japan, the number of vehicles equipped with an immobilizer is on the rise.

In an immobilizer, a small electronic communications chip referred to as a transponder is embedded into (a grip of) a vehicle key. When such key is fitted into a key cylinder of the vehicle, a user ID code pre-stored in the transponder is transmitted to an antenna built in the key cylinder and read out. The read-out user ID code is then checked whether or not it is identical to a reference ID code pre-stored in an ECU of the vehicle. If these ID codes are identical, it is then certified that the key used is valid, allowing ignition of its engine and/or injection of fuel. On the other hand, if the ID codes are not identical, the ignition of the engine and the injection of fuel are then not allowed, preventing start-up of the engine with the key.

In the immobilizer system, to add or delete the valid key, it is required to register the ID code unique to the key into the vehicle or delete the registered ID code unique to the key from the vehicle. In adding or deleting the valid key, a system is proposed in which a sub key can be registered only when a master key (or a main key) is certified. See, for example, JP8-268228A, or JP2001-71868A.

However, in the conventional antitheft apparatus for a vehicle using the immobilizer as described above, the valid keys are managed locally in the vehicle. Therefore, to know the keys registered on a certain vehicle, such keys have to be read out locally from that vehicle.

Such conventional system in which the registered keys cannot be seen from outside of the vehicle may lead to some disadvantages. Two illustrative scenarios are now described.

One illustrative scenario is a case where a valid vehicle user commits insurance fraud in which the user tries to receive an insurance payment from an insurance company for the reason that the user's vehicle is stolen even though that is not true. Typically, the insurance company is supposed to collect all keys of the stolen vehicle from the vehicle user when paying the insurance money to the user. Therefore, if the defrauding vehicle user conceals his/her vehicle by, for example, temporarily leaving it with someone and submits fake keys, which look like the valid keys in appearance, to the insurance company, the latter cannot determine whether or not the submitted keys are valid keys of which ID codes are registered on the stolen vehicle.

Another illustrative scenario is a case where the valid vehicle user having actually his/her vehicle stolen, which vehicle is provided with the immobilizer, properly receives the insurance payment from the insurance company. Since in general the vehicle with the immobilizer is more difficult to be stolen than a vehicle without it, the insurance company may conduct a relatively careful investigation over a claim for insurance from the vehicle user in other perspectives than the keys in order to determine whether or not the claim is insurance fraud as described above. Thus, when the vehicle is stolen, it may happen that it takes longer time for the valid user of the vehicle with the immobilizer to properly receive the insurance payment than the valid user of the vehicle without the immobilizer.

Furthermore, with the above conventional antitheft apparatus for a vehicle using the immobilizer, it is required to use a dedicated reader when one reads out the registered ID codes from the vehicle locally.

### DISCLOSURE OF THE INVENTION

To solve the above-mentioned problems, it is a main object of this invention to provide an antitheft apparatus for a vehicle and a vehicle antitheft system, which enable remote recognition of the immobilizer ID codes registered on the vehicle.

One aspect of this invention to achieve the above object is an antitheft apparatus for a vehicle, which is installed on the vehicle and configured to allow operation of predetermined on-vehicle devices only when a user ID code obtained from a user of the vehicle and a reference ID code registered on the vehicle are identical, including a setting unit for adding or deleting the reference ID code to or from the vehicle and a transmitting unit for transmitting the reference ID code registered on the vehicle to a predetermined communications station.

In the context of this aspect, the predetermined on-vehicle devices are intended to include, for example, devices relating to operation of a source of power (e.g. the engine) such as an ignition device, a fuel injection device, an engine ECU, and the like.

According to this aspect, the reference ID codes registered on the vehicle are to be transmitted to the predetermined communications station outside of the vehicle. Therefore, the reference ID codes registered on a certain vehicle can be easily recognized from outside of that vehicle by, for example, associating the reference ID codes transmitted from the vehicle with the latter and storing them locally in the communications station or in a remote station in communication with the communications station.

Furthermore it is preferred in this aspect that when a new reference ID code is added to or a registered reference ID code is deleted from the vehicle via the setting unit, the transmitting unit transmits information relating to the added new reference ID code or the deleted registered reference ID code to the predetermined communications station, so that the latest list of the registered ID codes can be seen from the outside of the vehicle.

Another aspect of this invention to achieve the above object is a vehicle antitheft system including an antitheft apparatus for a vehicle, which is installed on a vehicle and configured to allow operation of predetermined on-vehicle devices only when a user ID code obtained from a user of the vehicle and a reference ID code registered on the vehicle are identical, and a communications station for communicating with the antitheft apparatus for a vehicle, the antitheft apparatus for a vehicle including a setting unit for adding or deleting the reference ID code to or from the vehicle and a transmitting unit for transmitting, when a new reference ID code is added to or a registered reference ID code is deleted from the vehicle via the setting unit, information relating to the added new reference ID code or the deleted registered reference ID code to the communications station, and the communications station being configured to associate the added new ID code, on the basis of the addition information of the reference ID code transmitted from the transmitting unit of the antitheft apparatus for a vehicle, with the vehicle from which the information is transmitted and to then store it into a database, and being also configured to delete the deleted registered reference ID code, on the basis of the deletion information of the reference ID code transmitted from the transmitting unit of the antitheft apparatus for a vehicle, from the database into which it is stored with being associated with the vehicle from which the information is transmitted.

### BRIEF DESCRIPTION OF THE DRAWINGS

The foregoing and other objects, features, and advantages of the present invention will become apparent upon reading the following detailed description and upon reference to the drawing in which:

FIG. 1 is a schematic view showing an antitheft apparatus for a vehicle according to an embodiment of the present invention.

### PREFERRED EMBODIMENTS FOR CARRYING OUT THE INVENTION

A preferred embodiment of the present invention is now described with reference to the appended drawing. Note that the basic concept, the main hardware configuration, the principle of operation, and the basic control scheme of the antitheft apparatus for a vehicle using the immobilizer are not described in detail in the following description because such matters are known to the skilled person in the art.

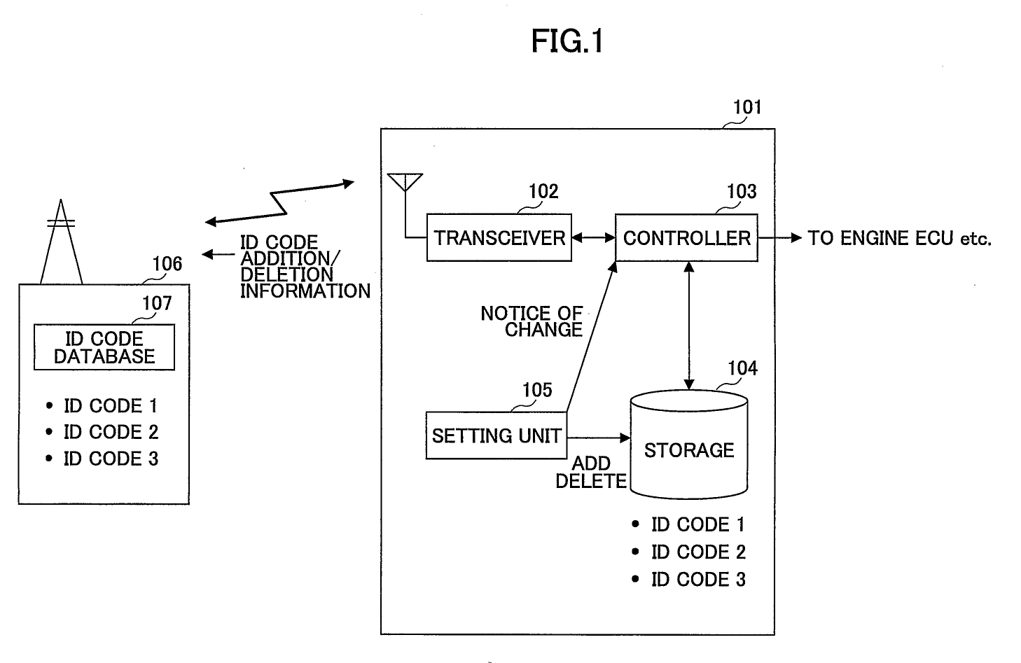

FIG. 1 schematically shows an antitheft apparatus for a vehicle according to this embodiment.

The antitheft apparatus for a vehicle 101 is installed on a vehicle and includes a transceiver 102, a controller 103 (e.g. an ECU), storage 104 (e.g. a storage media such as a memory), and a setting unit 105 for registering or deleting identification (ID) codes.

The transceiver 102 can communicate with a center 106, which center is an authorized communications station that can perform radio communication. The center 106 is provided with an ID code database 107, which database is configured to associate the registered ID codes transmitted from the vehicle with the latter and to store them.

The controller 103 is configured to control an immobilizer system and has a function to check whether or not a user ID code pre-stored in a transponder of a vehicle key fitted into a key cylinder of the vehicle and a reference ID code stored in the storage 104 are identical and to send a command to disable the starting-up of the engine to the engine ECU and the like when the user ID code and the reference ID code are not identical.

The setting unit 105 is configured to register (add) a new reference ID code to the storage 104 and to delete the registered reference ID code from the storage 104, based on the user's request.

The antitheft apparatus for a vehicle 101 of this embodiment has the above-mentioned components. Next, the operation of the antitheft apparatus 101 of this embodiment is described.

When the setting unit 105 newly or additionally registers the ID code to the storage 104, the setting unit 105 notifies the controller 103 of the registration of the ID code. When the controller 103 receives the notice of registration of the ID code, the controller 103 transmits information relating to the newly or additionally registered ID code, which is referred to as “ID code addition information” hereinafter, to the center 106 in communication data via the transceiver 102.

The ID code addition information may include the ID code itself newly or additionally registered in the storage 104, or information for identifying the newly or additionally registered ID code.

When the center 106 receives the ID code addition information from the vehicle, the center 10 6 associates the ID code indicated in the received ID code addition information with the vehicle from which the ID code addition information is transmitted and stores them in the ID code database 107.

On the other hand, when the setting unit 105 deletes the registered ID code from the storage 104, the setting unit 105 notifies the controller 103 of the deletion of the ID code. When the controller 103 receives the notice of deletion of the ID code, the controller 103 transmits information relating to the deleted ID code, which is referred to as “ID code deletion information” hereinafter, to the center 106 in communication data via the transceiver 102.

The ID code deletion information may include the ID code itself deleted from the storage 104, or information for identifying the deleted ID code.

When the center 106 receives the ID code deletion information from the vehicle, the center 10 6 deletes the ID code indicated in the received ID code deletion information from a field for the vehicle from which the ID code deletion information is transmitted in the ID code database 107.

The above-mentioned transmission of the ID code addition/deletion information from the antitheft apparatus 101 to the center 106 occurs each time the ID codes registered in the storage 104 are changed by the setting unit 105. Thus, for each vehicle, the ID codes registered locally on the vehicle and the ID codes stored in the center 106 are kept identical. Consequently, the ID codes currently registered on a certain vehicle can be easily recognized by making reference to the ID code database 107.

In an example shown, by way of example, the ID Codes 1-3 are stored in the storage 104, and accordingly the same ID Codes 1-3 are stored in the ID code database 107 of the center 106 as the registered ID codes. In this example, assuming that the setting unit 105 adds the ID Code 4 (not shown) to the storage 104, the ID code addition information requesting the addition of the ID Code 4 to the ID code database 107 is then transmitted to the center 106. Further, in this example, assuming that the setting unit 105 deletes the ID Code 1 from the storage 104, the ID code deletion information requesting the deletion of the ID Code 1 from the ID code database 107 is then transmitted to the center 106.

Thus, according to this embodiment, the immobilizer ID codes currently registered on each vehicle can be easily seen from outside of the vehicle without any dedicated reader.

The ID codes currently registered on each vehicle can be found in such manner and may be used by, for example, the insurance company. If the insurance company includes the center 106 of this embodiment or can receive information from the center 106 of this embodiment, the insurance company can then easily and quickly determine whether or not a claim for insurance payment is valid when a user of a vehicle with the immobilizer makes a claim for insurance payment for the reason that his/her vehicle is stolen, by demanding that the user submits the registered keys of the vehicle.

The insurance company can easily recognize all registered ID codes (and also the total number of the registered ID codes) of the vehicle supposed to have been stolen according to the user claiming the insurance payment by making reference to the ID code database 107 for that vehicle. Then, the insurance company can check whether or not the ID codes stored in the transponders of the keys submitted by the claiming user are identical to the registered ID codes known from the ID code database 107. Therefore, the insurance company can determine that the claim for the insurance payment is valid when the user ID codes stored in the transponders of the keys submitted by the claiming user are identical to the registered reference ID codes known from the ID code database 107 and when the total number of the user ID codes is identical to the total number of the reference ID codes. Consequently, the insurance company can find out a possibility of the insurance fraud when the user ID codes includes one or more ID codes that are not included in the reference ID codes or vice versa, or when the total number of the user ID codes is not identical to the total number of the reference ID codes.

This is advantageous for both the insurance company and the valid vehicle user claiming the insurance payment because the insurance company can easily find out the invalid insurance claim and the investigation for the insurance payment may be quickly finished so that the valid claiming user may quickly receive the insurance money.

In this embodiment, by way of example, an illustrative case where the ID code database 107 is located in the center 106 is described. However, the present invention is not limited to this and a case where the ID code database 107 is located in a remote station in communication with the center 106 is also within the scope of the present invention.

The present invention is applicable to any antitheft apparatus for a vehicle using the immobilizer and to any vehicle antitheft system using such apparatus. The present invention does not depend on visual design, weight, size, and performance of driving of the vehicle on which the antitheft apparatus of the present invention is installed.

The disclosure of Japanese Patent Application No. JP2004-066058 filed on Mar. 9, 2004 including the specification, drawings, and abstract is incorporated herein by reference in its entirety.

1. An antitheft apparatus for a vehicle, which is installed on a vehicle and configured to allow operation of predetermined on-vehicle devices only when a user ID code obtained from a user of the vehicle and a reference ID code registered on the vehicle are identical, comprising:
a setting unit for adding or deleting the reference ID code to or from the vehicle; and,
a transmitting unit for transmitting the reference ID code registered on the vehicle to a predetermined communications station.

2. The antitheft apparatus for a vehicle of claim 1, characterized in that:
when a new reference ID code is added to or a registered reference ID code is deleted from the vehicle via said setting unit, said transmitting unit transmits information relating to the added new reference ID code or the deleted registered reference ID code to said predetermined communications station.

3. The antitheft apparatus for a vehicle of claim 1 characterized in that:
said user ID code is an ID code registered on a vehicle key.

4. A vehicle antitheft system comprising an antitheft apparatus for a vehicle, which is installed on a vehicle and configured to allow operation of predetermined on-vehicle devices only when a user ID code obtained from a user of the vehicle and a reference ID code registered on the vehicle are identical, and a communications station for communicating with said antitheft apparatus for a vehicle, characterized in that:
said antitheft apparatus for a vehicle comprises a setting unit for adding or deleting the reference ID code to or from the vehicle, and a transmitting unit for transmitting, when a new reference ID code is added to or a registered reference ID code is deleted from the vehicle via said setting unit, information relating to the added new reference ID code or the deleted registered reference ID code to said communications station, and
said communications station is configured to associate the added new ID code, on the basis of the addition information of the reference ID code transmitted from said transmitting unit of the antitheft apparatus for a vehicle, with the vehicle from which the addition information is transmitted and to then store it into a database, and is also configured to delete the deleted registered reference ID code, on the basis of the deletion information of the reference ID code transmitted from said transmitting unit of the antitheft apparatus for a vehicle, from the database into which it is stored with being associated with the vehicle from which the deletion information is transmitted.
